(19) United States
(12) Patent Application Publication
(10) Pub. No.: US 2023/0362471 A1
(43) Pub. Date: Nov. 9, 2023

(54) COMMUNICATION METHOD OF WIRELESS CAMERA AND PLUGGABLE DEVICE

(71) Applicant: AVER INFORMATION INC., New Taipei City (TW)

(72) Inventors: Jien Shin WU, New Taipei City (TW); Wen Jui TENG, New Taipei City (TW)

(73) Assignee: AVER INFORMATION INC., New Taipei City (TW)

(21) Appl. No.: 18/137,967

(22) Filed: Apr. 21, 2023

(30) Foreign Application Priority Data
May 6, 2022 (TW) 111117145

(51) Int. Cl. G06F 3/14; H04N 23/60; H04W 76/10

(52) U.S. Cl. CPC H04N 23/60; G06F 3/14; H04W 76/10

(57) ABSTRACT

A communication method of a wireless camera comprising: connecting a pluggable device to a computing device, wherein the computing device is configured to be electrically connected to a display device; when the pluggable device determines that there is no pairing connection between the pluggable device and a wireless camera, transmitting a designated image to the computing device by the pluggable device, so that the computing device controls the display device to display the designated image, wherein the designated image has pairing data; capturing and analyzing the designated image to obtain the pairing data by the wireless camera, and establishing the pairing connection by the wireless camera according to the pairing data.

### CROSS-REFERENCE TO RELATED APPLICATIONS

This non-provisional application claims priority under 35 U.S.C. § 119(a) on Pat. Application No(s). 111117145 filed in Republic of China (ROC) on May, 6th, 2022, the entire contents of which are hereby incorporated by reference.

### BACKGROUND

### 1. Technical Field

This disclosure relates to a wireless camera and a wireless fidelity dongle, especially to a communication method of wireless camera and pluggable device.

### 2. Related Art

A general commercially available wireless network sharing device, such as a wireless fidelity dongle (Wi-Fi dongle), can be connected to the computing device through a plug-in method and served as another network interface of the computing device. The computing device can obtain the service set identifier (SSID) of the wireless network access point (AP) through the communication module of the wireless fidelity dongle. Then the user enters the password for the computing device to establish a communication connection with the wireless network access point, and finally the computing device can obtain the network address assigned by the wireless network access point and can connect through the wireless network access point to other network devices, such as wireless webcam.

However, in the above process, the wireless fidelity dongle is actually recognized as a wireless network card by the computing device. If the computing device recognizes the wireless fidelity dongle as an image device (such as a webcam), the computing device cannot select the SSID of the wireless fidelity dongle and establish a wireless communication connection. On the other hand, the wireless camera must also have an additional human-machine interface to display the SSID of the existing wireless network for users to view, and allow users to choose which wireless network access point to connect to. Through this method not only the hardware cost of the wireless camera is increased, but also the process of connecting the wireless camera to the wireless network access point becomes cumbersome. For users, this method lacks usability.

### SUMMARY

Accordingly, this disclosure provides a communication method of wireless camera and pluggable device to improve compatibility and usability of the wireless camera.

According to one or more embodiment of this disclosure, a communication method of wireless camera comprises: connecting a pluggable device to a computing device, wherein the computing device is configured to be electrically connected to a display device; when the pluggable device determines that there is no pairing connection between the pluggable device and the wireless camera, the designated image is transmitted to the computing device by the pluggable device for the computing device controls the display device to display the designated image, wherein the designated image has pairing data.

According to one or more embodiment of this disclosure, a pluggable device is configured for communication connection with a wireless camera and configured to electrically connected to a computing device, the computing device is configured to electrically connected to a display device, and the pluggable device comprises: a connection port, a communication circuit, a storage device, a conversion circuit and a control circuit. The connection port is pluggably connected to the computing device. The communication circuit is configured to receive images captured by the wireless camera through the pairing connection between the pluggable device and the wireless camera. The storage device is configured to store the image captured by the wireless camera and a designated image, and the designated image has pairing data. The conversion circuit is electrically connected to the connection port, the storage device and the communication circuit. The conversion circuit is configured to convert the designated image into the first electronic signal, and convert the image captured by the wireless camera into the second electronic signal. The control circuit is electrically connected to the communication circuit, the storage device and the conversion circuit. The control circuit is configured to control the storage device to output a designated image to the conversion circuit when determining that there is no paired connection, control the conversion circuit to convert the designated image into the first electronic signal, and control the connection port to transmit the first electronic signal to the computing device, for the computing device to control the display device to display a designated image, and to control the communication circuit to establish a pairing connection with the wireless camera.

In view of the above description, the pluggable device of the present disclosure can use the original capturing function of the wireless camera and the communication method of the wireless camera proposed by the present disclosure to perform pairing and connection without a user input interface and a display interface. This process is with high usability for users and saves the hardware cost of the wireless camera.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic diagram of the application of a pluggable device according to an embodiment of the present disclosure;

FIG. 2 is an internal structure diagram of a pluggable device according to an embodiment of the present disclosure;

FIG. 3 is an internal structure diagram of a wireless camera compatible with a pluggable device according to an embodiment of the present disclosure;

FIG. 4 is a flowchart of a communication method of a wireless camera according to an embodiment of the present disclosure;

FIGS. 5A-5B are flowcharts of the operation of the pluggable device according to an embodiment of the present disclosure;

FIGS. 6A-6B are flowcharts of the operation of a wireless camera compatible with a pluggable device according to an embodiment of the present disclosure;

FIG. 7 is a flowchart of the operation of a computing device compatible with a pluggable device and a display device according to an embodiment of the present disclosure; and

FIG. 8 is a flowchart of a communication method of a wireless camera according to another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

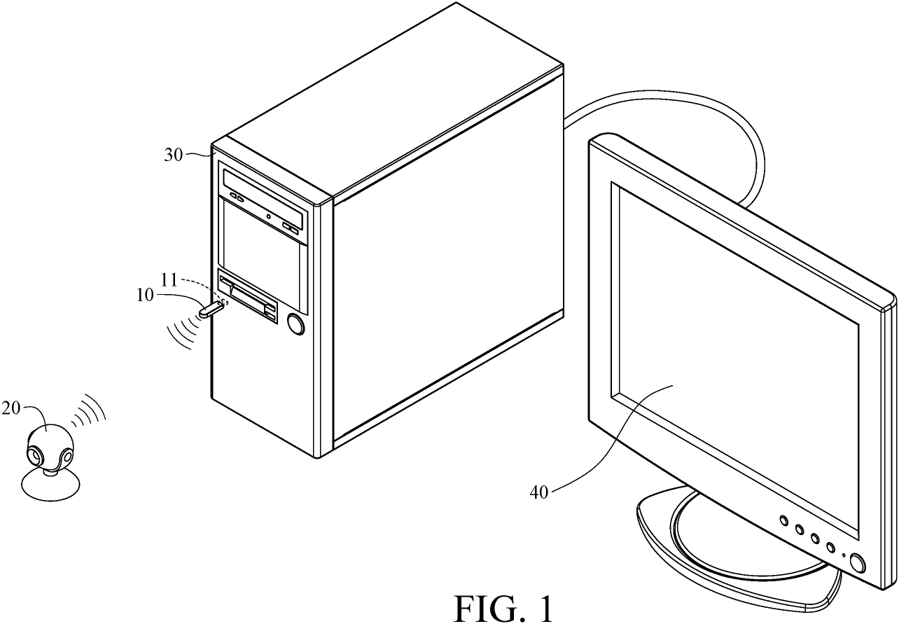

Please refer to FIG. 1 which is a schematic diagram of the application of a pluggable device according to an embodiment of the present disclosure. As shown in FIG. 1, a pluggable device 10 is configured for communication connection with a wireless camera 20 and configured to be electrically connected to a computing device 30, and the computing device 30 is configured to be electrically connected to a display device 40. In one embodiment, the pluggable device 10 is a dongle. In one embodiment, the computing device 30 is, for example, a personal computer. In one embodiment, the computing device 30 and the display device 40 are integrated into one device, such as a smart phone, a tablet computer, a smart TV, etc., but the above examples are not limited herein. In one embodiment, the computing device 30 is configured to run video conferencing software such as Zoom and Teams.

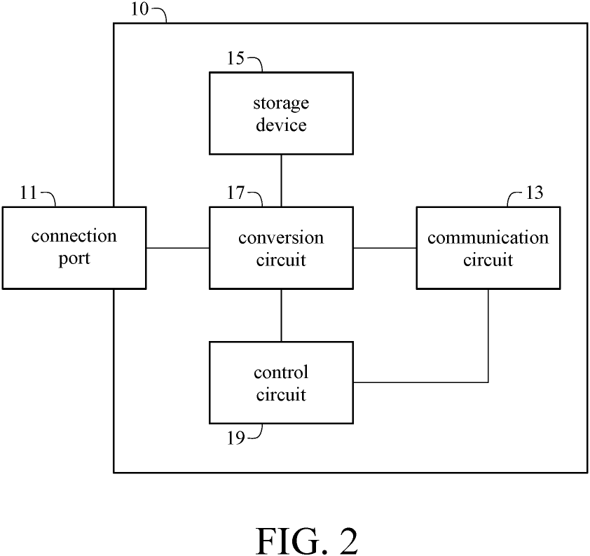

Please refer to FIG. 2 along with FIG. 1, wherein FIG. 2 is an internal structure diagram of a pluggable device 10 according to an embodiment of the present disclosure. The pluggable device 10 comprises: a connection port 11, a communication circuit 13, a storage device 15, a conversion circuit 17 and a control circuit 19.

The connection port 11 is pluggably connected to the computing device 30. In one embodiment, the connection port 11 is a Universal Serial Bus (USB).

The communication circuit 13 is configured to establish a pairing connection between the pluggable device 10 and an external wireless network terminal device. In one embodiment, the external wireless network terminal device is, for example, the wireless camera 20, and the communication circuit 13 is configured to receive images captured by the wireless camera 20 through the established pairing connection. In one embodiment, the communication circuit 13 supports wireless fidelity (Wi-Fi). In one embodiment, the communication circuit 13 is configured to provide a service set identifier (SSID). If the external wireless network terminal device provides the correct SSID and password to establish a pairing connection with the communication circuit 13, the communication circuit 13 will assign network addresses to external wireless network terminal devices and provide communication functions.

The storage device 15 is configured to store images captured by the wireless camera 20, designated images and firmware. In one embodiment, the storage device 15 is a programmable read-only memory (PROM), an erasable programmable read-only memory (EPROM), a one-time programmable read-only memory (OTPROM), an electrically-erasable programmable read-only memory (EEPROM), or a flash memory. In one embodiment, the firmware is a program stored in the storage device 15. The designated image has pairing data. In one embodiment, the designated image is a Quick Response code (QR code). In one embodiment, the pairing data is at least one of an SSID and a password corresponding to the SSID. The SSID corresponding to each pluggable device 10 is unique, so that multiple pluggable devices 10 that are at the same place at the same time are prevented from causing pairing confusion.

The present disclosure modifies the firmware in the pluggable device 10. After the pluggable device 10 is electrically connected to the computing device 30, the pluggable device 10 is recognized as an image device by the computing device 30, such as USB video class (UVC) camera, instead of a wireless network access point (Wi-Fi AP). Specifically, the present disclosure allows the computing device 30 to access the information in the firmware through the connection port 11 by program coding, and the information corresponds to the USB video category.

The conversion circuit 17 is electrically connected to the connection port 11, the storage device 15 and the communication circuit 13. The conversion circuit 17 is configured to convert the designated image into a first electronic signal, and convert the image captured by the wireless camera 20 into a second electronic signal. In one embodiment, the first electronic signal conforms to the USB transmission format; in other words, the conversion circuit 17 converts the data in the image format into the electronic signal in the USB transmission format. In one embodiment, the image captured by the wireless camera 20 received from the communication circuit 13 is in a wireless network packet format. The conversion circuit 17 first converts the wireless network packet format into data in image format, and then converts the data in image format into a second electronic signal conforming to the USB transmission format. In other words, the format of the second electronic signal is the USB transmission format. In one embodiment, the conversion circuit 17 is, for example, at least one of an application specific integrated circuit (ASIC), a digital signal processor (DSP), a field programmable logic gate array (FPGA), or a system-on-a-chip (SOC) integrated with at least one of the above modules.

The control circuit 19 is electrically connected to the communication circuit 13, the storage device 15 and the conversion circuit 17. The control circuit 19 is configured to determine whether there is a pairing connection (whether a pairing connection exists) between the communication circuit 13 and the wireless camera 20. In one embodiment, the method for the control circuit 19 to determine whether there is a pairing connection is as follows: the control circuit 19 determines whether the communication circuit 13 stores a network address for assigning to the wireless camera 20. In one embodiment, the control circuit 19 is, for example, at least one of an application specific integrated circuit (ASIC), a digital signal processor (DSP), a field programmable logic gate array (FPGA), or a system-on-a-chip (SOC) integrated with at least one of the above modules.

When the control circuit 19 determines that there is no pairing connection (the pairing connection does not exist), the control circuit 19 controls the storage device 15 to output the designated image to the conversion circuit 17, and controls the conversion circuit 17 to convert the designated image into a first electronic signal, and controls the connection port 11 to transmit the first electronic signal to the computing device 30 through the conversion circuit 17, for the computing device 30 to control the display device 40 to display the designated image, and to control the communication circuit 13 to establish a pairing connection with the wireless camera 20. After establishing the pairing connection with the wireless camera 20 according to the pairing data, the control circuit 19 determines whether there is a pairing connection (the pairing connection exists) between the pluggable device 10 and the wireless camera 20, again.

When the control circuit 19 determines that there is a pairing connection, the control circuit 19 controls the communication circuit 13 to receive the image captured by the wireless camera 20, controls the conversion circuit 17 to convert the image captured by the wireless camera 20 into a second electronic signal, and controls the connection port 11 to transmit the second electronic signal to the computing device 30.

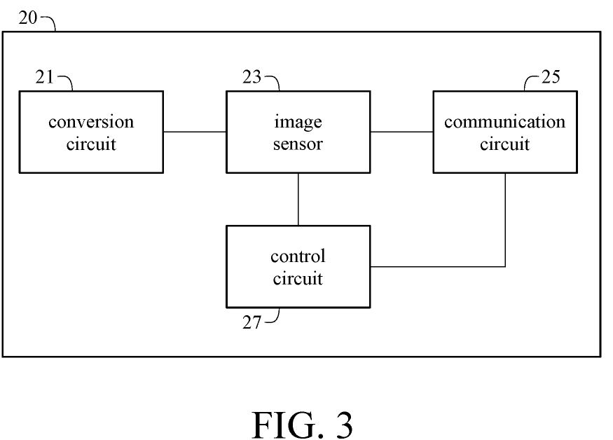

Please refer to FIG. 3 along with FIG. 1, wherein FIG. 3 is an internal structure diagram of a wireless camera 20 compatible with a pluggable device according to an embodiment of the present disclosure. In one embodiment, the wireless camera 20 has a lens 21, an image sensor 23, a communication circuit 25 and a control circuit 27, and the wireless camera 20 does not have a hardware interface or a software interface for user input. In other words, the user does not pair and connect the wireless camera 20 to the wireless network access point by manually inputting the SSID.

The image sensor 23 in the wireless camera 20 is electrically connected to the lens 21 and configured to capture image data through the lens 21.

The communication circuit 25 in the wireless camera 20 is configured to establish a pairing connection with the pluggable device 10, and transmit image data through the pairing connection. In one embodiment, the communication circuit 25 has a Wi-Fi terminal (Station) function. The Wi-Fi terminal is configured for external network communication, which needs to go through the Wi-Fi access point pairing authentication SSID and password first to obtain the network address before communicating externally.

The control circuit 27 in the wireless camera 20 is electrically connected to the image sensor 23 and the communication circuit 25, and is configured to detect whether there is pairing data in the image data. In other words, if the wireless camera 20 captures the designated image presented by the display device 40, the control circuit 27 may analyze the SSID and its password, and control the communication circuit 25 to establish a pairing connection with the above information. In one embodiment, the control circuit 27 in the wireless camera 20 is, for example, at least one of an application specific integrated circuit (ASIC), a digital signal processor (DSP), a field programmable logic gate array (FPGA), or a system-on-a-chip (SOC) integrated with at least one of the above modules.

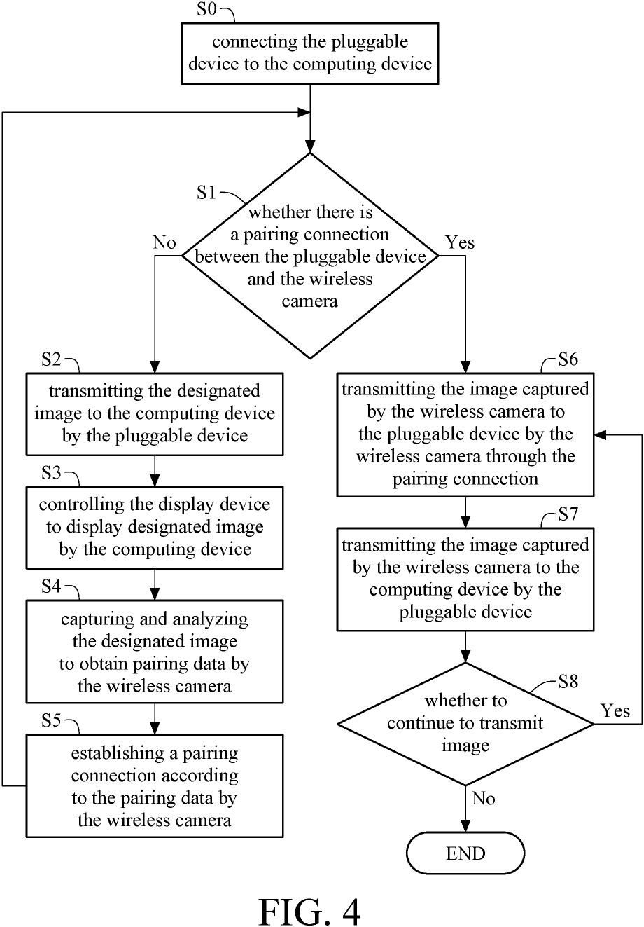

Please refer to FIG. 4 along with FIG. 1, wherein FIG. 4 is a flowchart of a communication method of a wireless camera according to an embodiment of the present disclosure. As shown in FIG. 4, the communication method of the wireless camera includes steps S0-S8. Step S0 is “connecting the pluggable device to the computing device”. Step S1 is determining “whether there is a pairing connection between the pluggable device and the wireless camera”. If the determination result of step S1 is “No”, then step S2 is executed. If the determination result of step S1 is “Yes”, then step S6 is executed. Step S2 is “transmitting the designated image to the computing device by the pluggable device”. Step S3 is “controlling the display device to display designated image by the computing device”. Step S4 is “capturing and analyzing the designated image to obtain pairing data by the wireless camera”. Step S5 is “establishing a pairing connection according to the pairing data by the wireless camera”, and the method is returned to step S1 after step S5 is completed. Step S6 is “transmitting the image captured by the wireless camera to the pluggable device by the wireless camera through the pairing connection”. Step S7 is “transmitting the image captured by the wireless camera to the computing device by the pluggable device”, and step S8 is determining “whether to continue to transmit image”. If the determination result of step S8 is “Yes”, then the method is returned to step S6. If the determination result of step S8 is “No”, the communication method of the wireless camera according to an embodiment of the present invention is ended.

In an embodiment of step S0, the user manually electrically connects the pluggable device 10 to the computing device, for example, by inserting a plug-in with a USB port into a USB interface of the computer.

In step S1, the control circuit 19 determines whether the communication circuit 13 stores the network address for assigning to the wireless camera 20. If the communication circuit 13 stores the network address assigned to the wireless camera 20, the determination result of step S1 is “Yes”, otherwise the determination result of step S1 is “No”.

In step S2, the control circuit 19 transmits the designated image stored in the storage device 15 to the computing device 30 through the connection port 11.

In step S3, the designated image is, for example, a QR code, and the QR code contains pairing data such as SSID and its password.

In step S4, the user manually captures a designated image displayed on the display device 40 with the lens 21 of the wireless camera 20, and the control circuit 27 of the wireless camera 20 analyzes the captured image to obtain pairing data.

In step S5, the control circuit 27 of the wireless camera 20 controls the communication circuit 25 of the wireless camera 20 to establish a pairing connection according to the pairing data. After step S5 is completed, the method is returned to step S1, that is, after establishing the pairing connection with the wireless camera 20 according to the pairing data, the pluggable device 10 is configured to determine whether there is a pairing connection between the pluggable device 10 and the wireless camera 20 again. In one embodiment, the control circuit 19 in the pluggable device 10 may periodically check whether the communication circuit 13 in the pluggable device 10 has stored a network address for assigning to the wireless camera 20, and the communication circuit 25 of the wireless camera 20 may send a pairing request signal to the pluggable device 10 when the pairing connection is established in step S5, and the communication circuit 13 of the pluggable device 10 will end the periodical check after receiving the pairing request signal, so that when the method is returned to step S1 from step S5, the determination result of step S1 will be “yes” directly.

In step S6, the communication circuit 25 of the wireless camera 20 transmits the image captured by the wireless camera 20 to the pluggable device 10 through the pairing connection.

In step S7, the pluggable device 10 transmits the image captured by the wireless camera 20 received from the wireless camera 20 to the computing device 30 through the connection port 11.

In an embodiment of step S8, the control circuit 19 in the pluggable device 10 determines whether to continue to transmit images according to the determination of whether a request for image transmission is received from the computing device.

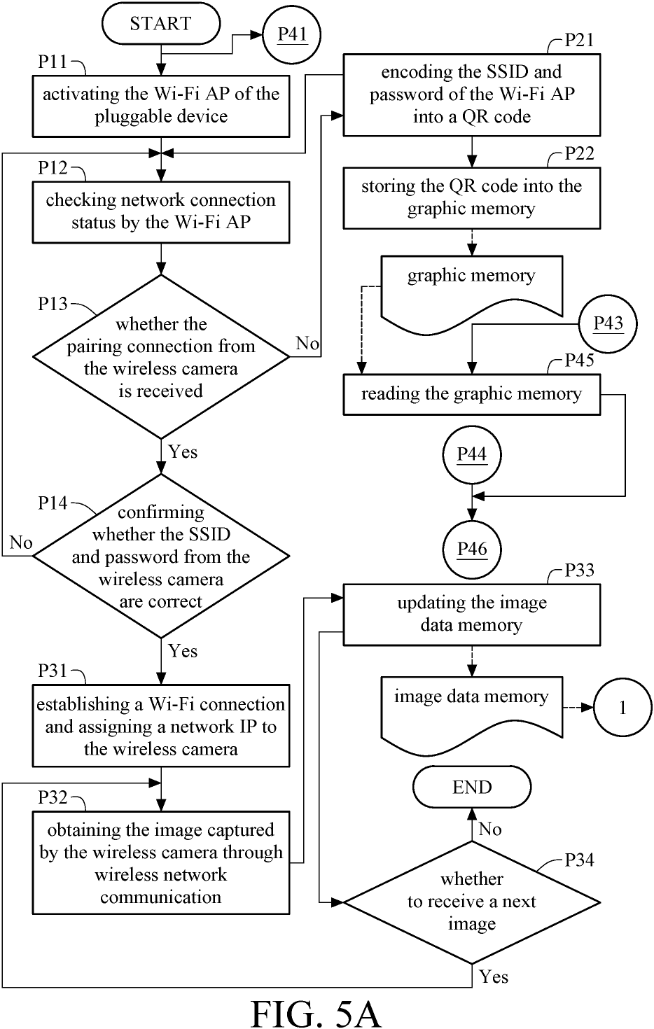

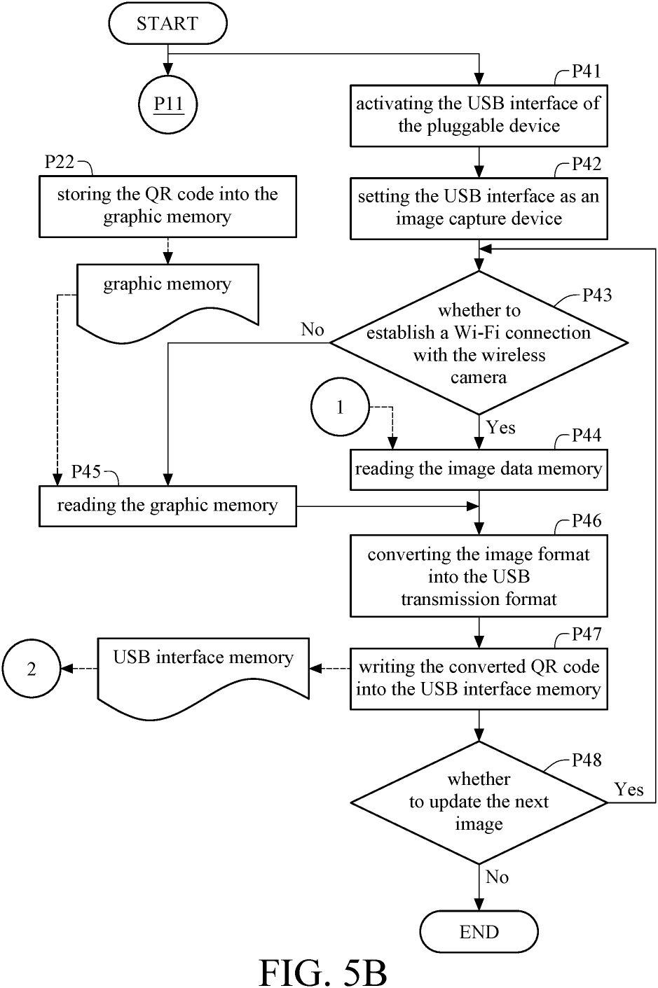

The following FIGS. 5A-5B, FIGS. 6A-6B and FIG. 7 are detailed flowcharts illustrating the operations of the pluggable device, the wireless camera and the computing device, respectively. Basically, the steps in FIG. 5A to FIG. 7 may be generalized to a certain step in FIG. 4.

FIGS. 5A-5B are flowcharts of the operation of the pluggable device according to an embodiment of the present disclosure.

Step P11 is “activating the Wi-Fi AP of the pluggable device”, wherein the Wi-Fi AP is an embodiment of the aforementioned communication circuit 13. Step P12 is “checking network connection status by the Wi-Fi AP″. Step P13 is, executed by the Wi-Fi AP, determining “whether the pairing connection from the wireless camera is received”. If the determination result of step P13 is “Yes”, then step P14 is executed. If the determination result of step P13 is “No”, then step P21 is executed. Step P14 is, executed by the Wi-Fi AP, “confirming whether the SSID and password from the wireless camera are correct”, wherein the SSID and password are an embodiment of the aforementioned pairing data. If the determination result of step P14 is “Yes”, then step P31 is executed. If the determination result of step P13 is “No”, then the method is returned to step P12. Step P11 corresponds to step S0, and steps P12-14 correspond to step S1.

Step P21 is, executed by the control circuit 19, “encoding the SSID and password of the Wi-Fi AP into a QR code”. Step P22 is, executed by the control circuit 19, “storing the QR code into the graphic memory”. The SSID and its password are an embodiment of the aforementioned pairing data. The QR code is an embodiment of the aforementioned designated image. The graphic memory is a storage space in the aforementioned storage device 15, which is specifically used to store the designated image including the pairing data, so the storage space of the graphic memory is different from the storage space of the image data memory. In one embodiment, each time the Wi-Fi AP of the pluggable device is activated, the communication circuit 13 of the pluggable device 10 may randomly generate at least one of the SSID and its password. The control circuit 19 encodes the SSID and the password generated by the communication circuit 13 to generate a QR code including the SSID and the password. In one embodiment, the SSID and its password of the pluggable device 10 are fixed, so step P21 and step P22 may be omitted. Steps P21-P22 correspond to step S2.

Step P31 is, executed by the Wi-Fi AP, “establishing a Wi-Fi connection and assigning a network IP to the wireless camera”. Step P32 is, executed by the Wi-Fi AP, “obtaining the image captured by the wireless camera through wireless network communication”. Step P33 is, executed by the control circuit 19 and the conversion circuit 17, “updating the image data memory”. In detail, the image obtained in step P32 is in a wireless network packet format, so the control circuit 19 controls the conversion circuit 17 to convert the wireless network packet format into an image format, and then controls the conversion circuit 17 to store the converted data into the image data memory. The image data memory is a storage space in the storage device 15. Step P34 is, executed by the control circuit 19, determining “whether to receive a next image”. If the determination result of step P34 is “Yes”, then the method is returned to step P32. If the determination result of step P13 is “No”, then the operation process of the pluggable device 10 is ended. In one embodiment, the determination of step P34 is based on a command from the computing device 30, and if the computing device 30 requests the pluggable device 10 to provide the next image, the determination result of step P34 is “Yes”. If the computing device 30 does not request the pluggable device 10 to provide the next image, the determination result of step P34 is “No”. Step P31 may correspond to step S5. Step P32 may correspond to step S6. Step P33 may correspond to step S7. Step P34 may correspond to step S8.

Step P41 is “activating the USB interface of the pluggable device”. The USB interface is an embodiment of the aforementioned connecting port 11. When the user connects the pluggable device 10 to the computing device 30, the USB interface of the pluggable device 10 can be activated. Step P42 is, executed by the control circuit, “setting the USB interface as an image capture device”. In detail, the computing device 30 accesses the firmware in the storage device 15 through the connection port 11, and the information contained in the firmware allows the computing device 30 to recognize the pluggable device 10 as a UVC camera instead of a Wi-Fi AP. Step P43 is, executed by the communication circuit 13, determining “whether to establish a Wi-Fi connection with the wireless camera”. If the determination result of step P43 is “Yes”, then step P44 is executed. If the determination of step P43 is “No”, then step P45 is executed. Step P44 is, executed by the control circuit 19, controlling the conversion circuit 17 “reading the image data memory”. Since the pluggable device 10 has established a communication connection with the wireless camera 20, the image memory stores the image which is captured by the wireless camera 20 and transmitted to the pluggable device through the network. Step P45 is, executed by the control circuit 19, controlling the conversion circuit 17 “reading the graphic memory”. Because the pluggable device 10 has not yet established a communication connection with the wireless camera, there is no data in the image memory, and the QR code is stored in the graphic memory. The conversion circuit 17 reads the graphic memory to obtain the QR code. Step P46 is, executed by the conversion circuit 17, “converting the image format into the USB transmission format”. Step P47 is, executed by the control circuit 19, controlling the conversion circuit 17 “writing the converted QR code into the USB interface memory”. After the data is written into the USB interface memory, the control circuit 19 may control the connection port 11 to transmit the data in the USB interface memory to the computing device 30. Step P48 is, executed by the control circuit 19, determining “whether to update the next image”. If the determination result of step P48 is “Yes”, then the method is returned to step P43. If the determination result of step P48 is “No”, then the operation of the pluggable device 10 is ended. Steps P41-P42 may correspond to step S0. Step P41 may correspond to step S1. Step P44 may correspond to step S7. The process of steps P45-P47 may correspond to the process of steps S2-S3. Step P48 may correspond to step S8.

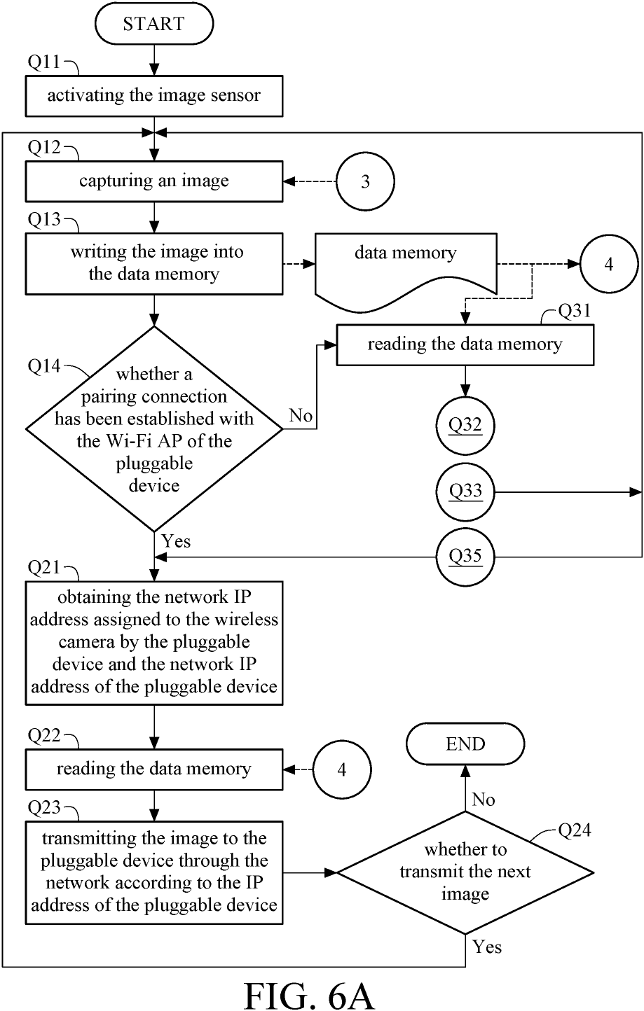

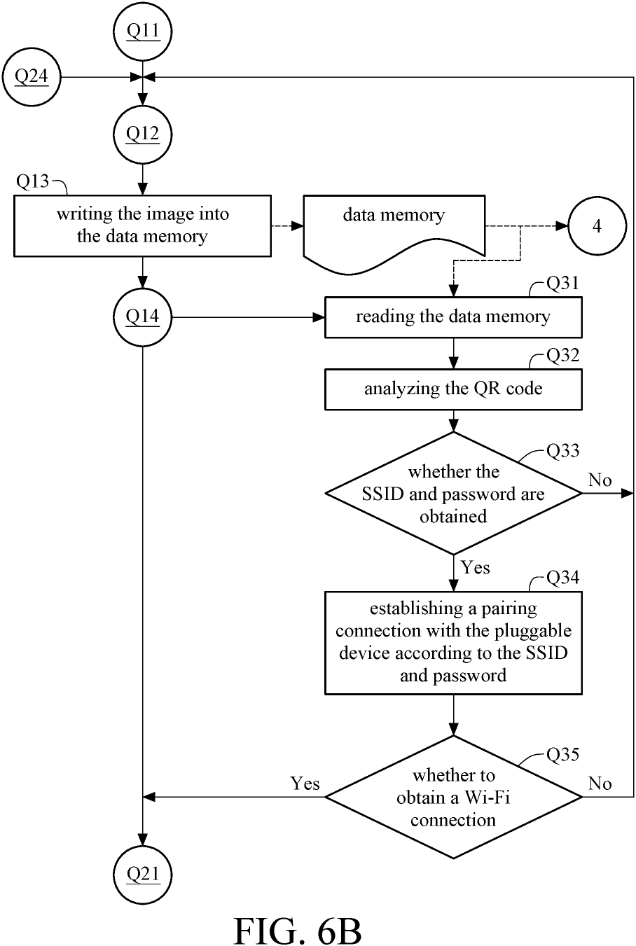

FIGS. 6A-6B are flowcharts of the operation of a wireless camera compatible with a pluggable device according to an embodiment of the present disclosure.

Step Q11 is, executed by the wireless camera 20, “activating an image sensor”, step Q12 is, executed by the lens 21, “capturing an image”, and step Q13 is writing the image into the data memory. In detail, after the wireless camera 20 is turned on, the activated image sensor 23 may obtain the image captured by the lens 12, and then the control circuit 27 of the wireless camera 20 may write the image sensed by the image sensor into the data memory of the wireless camera 20. Step Q14 is, by the communication circuit 25 of the wireless camera 20, determining “whether a pairing connection has been established with the Wi-Fi AP of the pluggable device”. If the determination result of step Q14 is “Yes”, step Q21 is executed, and if the determination result of step Q14 is “No”, step Q31 is executed. The process of steps Q11-Q13 belongs to the operation process of the wireless camera 20 itself after the user manually activates the wireless camera 20, and the pluggable device 10 does not participate in this process. Step Q14 may correspond to step S1.

Step Q21 is, executed by the communication circuit 25 of the wireless camera 20, “obtaining the network IP address assigned to the wireless camera by the pluggable device and the network IP address of the pluggable device”. Step Q22 is, executed by the control circuit 27 of the wireless camera 20, “reading the data memory” to obtain the image captured by the wireless camera 20. Step Q23 is, executed by the control circuit 27 of the wireless camera 20, “transmitting the image to the pluggable device through the network according to the IP address of the pluggable device”. Step Q24 is, executed by the control circuit 27 of the wireless camera 20, determining “whether to transmit the next image”. In one embodiment, if the communication circuit 25 of the wireless camera 20 receives an instruction from the pluggable device 10 to transmit the next image, the determination result of step Q24 is “Yes”, and the method is returned to step Q12 to capture the next image. If the communication circuit 25 of the wireless camera 20 does not receive an instruction from the pluggable device 10 to transmit the next image, the determination result of step Q25 is “No”, and the operation process of the wireless camera 20 is ended. Step Q21 may correspond to step P31 in FIGS. 6A-6B, and its execution timing is after step S1 in FIG. 4 and before step S6 in FIG. 4. Steps Q22-Q23 may correspond to step S6. Step Q24 may correspond to step S8 in FIG. 4 and step P48 in FIGS. 6A-6B.

Step Q31 is, executed by the control circuit 27 of the wireless camera 20, “reading the data memory” to obtain the image captured by the wireless camera 20. In detail, it is confirmed in step Q14 that the wireless camera 20 has not yet established a pairing connection with the pluggable device 10. Therefore, the user must point the lens 21 of the wireless camera 20 toward the display device 40 to capture a designated image (ie, a QR code) transmitted from the pluggable device 10 to the computing device 30 for display by the display device 40. Step Q31 may correspond to step S4.

Step Q32 is, executed by the control circuit 27 of the wireless camera 20, “analyzing the QR code”. Step Q33 is, executed by the control circuit 27 of the wireless camera 20, determining “whether the SSID and password are obtained”. If the determination result of step Q33 is “Yes”, then step Q34 is executed. If the determination result of step Q33 is “No”, then the method is returned to step Q12. Step Q34 is, executed by the communication circuit 25 of the wireless camera 20, “establishing a pairing connection with the pluggable device according to the SSID and password”. Step Q35 is, executed by the communication circuit 25 of the wireless camera 20, determining “whether to obtain a Wi-Fi connection”. If the determination result of step Q35 is “Yes”, then step Q21 is executed. If the determination result of step Q35 is “No”, then the method is returned to step Q12. The process of steps Q32-Q35 may correspond to the process of steps P13-P31 in FIGS. 6A-6B.

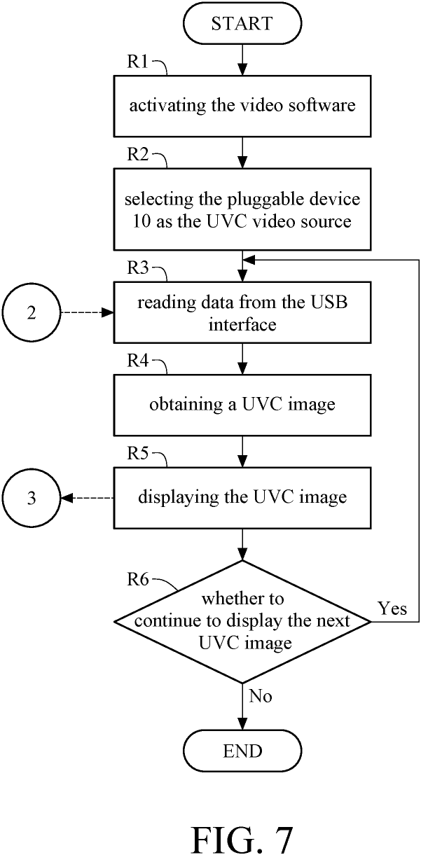

FIG. 7 is a flowchart of the operation of a computing device compatible with a pluggable device and a display device according to an embodiment of the present invention.

Step R1 is, executed by the computing device 30 “activating the video software”. Step R2 is, executed by the computing device 30, “selecting the pluggable device 10 as the UVC video source”. In other words, the computing device 30 takes the pluggable device 10 as a UVC camera. Step R3 is, executed by the computing device 30, “reading data from the USB interface” through the connection port 11 of the pluggable device 10. Step R4 is, executed by the computing device 30, “obtaining a UVC image” from the pluggable device 10. Step R5 is, executed by the computing device 30, controlling the display device 40 “displaying the UVC image”. Step R6 is, executed by the computing device 30, determining “whether to continue to display the next UVC image” according to the operation of the video software. If the determination result of step R6 is “Yes”, then the method is returned to step R3 to continue reading image data from the pluggable device 10. If the determination result of step R6 is “No”, then the operation process of the computing device 30 is ended. Step R2 may correspond to step S0. The process of steps R3-R4 may correspond to step S2 or step S7, and to which step that steps R3-R4 correspond to depends on whether the determination result of step S1 is “Yes” or “No”. Step R5 corresponds to step S3. Step R6 corresponds to step S8.

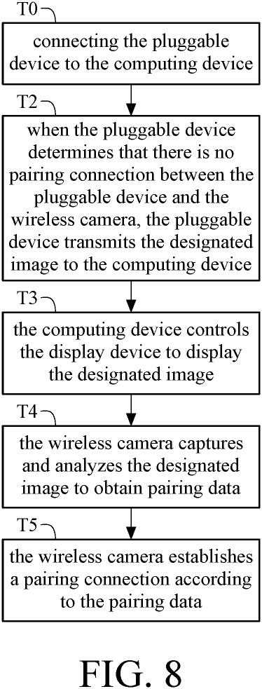

Please refer to FIG. 8 along with FIG. 1, wherein FIG. 8 is a flowchart of a communication method of a wireless camera according to another embodiment of the present invention. Step T0 is “connecting the pluggable device to the computing device”. Step T2 is “when the pluggable device determines that there is no pairing connection between the pluggable device and the wireless camera, the pluggable device transmits the designated image to the computing device”, so that the computing device controls the display device to display the designated image, wherein the designated image has pairing data. Step T3 is “the computing device controls the display device to display the designated image”. Step T4 is “the wireless camera captures and analyzes the designated image to obtain pairing data”, and step T5 is “the wireless camera establishes a pairing connection according to the pairing data”.

Step T0 is the same as step S0 in FIG. 4, and is not repeated herein.

In an embodiment of step T2, the control circuit 19 in the pluggable device 10 determines that the communication circuit 13 has not yet stored the network address assigned to the wireless camera 20, so there is no pairing connection between the pluggable device 10 and the wireless camera 20. The control circuit 19 transmits the designated image stored in the storage device 15 to the computing device 30 through the connection port 11. Steps T3 -T5 are the same as steps S3 - S5 in FIG. 4, and their descriptions are not repeated herein.

In view of the above description, the present disclosure provides a communication method of a wireless camera and a pluggable device. When connected to a computing device, the pluggable device is recognized as an image device, such as a standard USB video class (UVC) device. The computing device can use the pluggable device provided by the present disclosure without installing additional drivers. The UVC device proposed by the present disclosure has the function of a wireless fidelity access point (Wi-Fi AP), which can be used for wireless cameras to obtain network addresses after pairing and connection, and then the UVC device obtains the image captured by the wireless camera through wireless internet. The method for establishing a pairing connection proposed by the present disclosure is that the wireless camera captures the QR code presented by the UVC device through the display device, and the wireless camera obtains the SSID and its password from the QR code and then establishes a pairing connection with the UVC device.

In view of the above description, the pluggable device and the wireless camera can use the original image capturing function of the wireless camera for pairing and connection without setting up a user input interface and a display interface. This process is highly usable for users.

What is claimed is:

1. A communication method of wireless camera, comprising:
connecting a pluggable device to a computing device, wherein the computing device is configured to be electrically connected to a display device; and
when the pluggable device determines that a pairing connection does not exists between the pluggable device and a wireless camera, transmitting a designated image to the computing device by the pluggable device for the computing device to control the display device to display the designated image, wherein the designated image has pairing data.

2. The communication method of wireless camera of claim 1, further comprising:
when the pluggable device determines that the pairing connection exists between the pluggable device and the wireless camera, transmitting an image captured by the wireless camera to the pluggable device through the pairing connection by the wireless camera; and
transmitting the image captured by the wireless camera to the computing device by the pluggable device.

3. The communication method of wireless camera of claim 1, further comprising:
capturing and analyzing the designated image by the wireless camera to obtain the pairing data;
establishing the pairing connection by the wireless camera according to the pairing data; and
after establishing the pairing connection by the wireless camera according to the pairing data, determining whether the pairing connection exists between the pluggable device and the wireless camera again by the pluggable device.

4. The communication method of wireless camera of claim 1, wherein the pluggable device is connected to the computing device through a Universal Serial Bus (USB), and the pluggable device is recognized as an image device by the computing device.

5. The communication method of wireless camera of claim 2, wherein transmitting the image captured by the wireless camera to the computing device by the pluggable device comprises: converting a format of the image into a USB transmission format; and transmitting the image that is converted to the computing device.

6. A pluggable device, configured for communication connection with a wireless camera and configured to be electrically connected to a computing device, and the computing device configured to be electrically connected to a display device, wherein the pluggable device comprises:
a connection port pluggably connected to the computing device;
a communication circuit configured to receive an image captured by the wireless camera through a pairing connection between the pluggable device and the wireless camera;
a storage device configured to store the image captured by the wireless camera and a designated image, wherein the designated image has pairing data;
a conversion circuit electrically connected to the connection port, the storage device and the communication circuit, and the conversion circuit configured to convert the designated image into a first electronic signal and convert the image captured by the wireless camera into a second electronic signal; and
a control circuit electrically connected to the communication circuit, the storage device and the conversion circuit, and the control circuit configured to control the storage device to output the designated image to the conversion circuit when determining that the pairing connection does not exist, control the conversion circuit to convert the designated image into the first electronic signal, and control the connection port to transmit the first electronic signal to the computing device through the conversion circuit, so that the computing device controls the display device to display the designated image and controls the communication circuit to establish the pairing connection with the wireless camera.

7. The pluggable device of claim 6, wherein the control circuit is further configured to control the communication circuit to receive the image captured by the wireless camera, control the conversion circuit to convert the image captured by the wireless camera into the second electronic signal, and control the connection port to transmit the second electronic signal to the computing device when determining that the pairing connection exists.

8. The pluggable device of claim 6, wherein the control circuit is further configured to determine whether the pairing connection exists between the pluggable device and the wireless camera by the pluggable device again after establishing the pairing connection by the wireless camera according to the pairing data.

9. The pluggable device of claim 6, wherein the connection port is connected to the computing device through a Universal Serial Bus (USB), and the pluggable device is recognized as an image device by the computing device.

10. The pluggable device of claim 7, wherein a format of the second electronic signal is a USB transmission format.
